(19) United States
(12) Patent Application Publication
(10) Pub. No.: US 2025/0214483 A1
(43) Pub. Date: Jul. 3, 2025

(54) HYBRID VEHICLE AND ENERGY MANAGEMENT METHOD THEREFOR, APPARATUS, MEDIUM AND ELECTRONIC DEVICE

(71) Applicant: BYD COMPANY LIMITED, SHENZHEN, (CN)

(72) Inventors: Dongsheng YANG, Shenzhen (CN); Futang ZHU, Shenzhen (CN); Chunsheng WANG, Shenzhen (CN); Tao SHEN, Shenzhen (CN); Jinlong WU, Shenzhen (CN)

(21) Appl. No.: 19/086,734

(22) Filed: Mar. 21, 2025

Related U.S. Application Data
(63) Continuation of application No. PCT/CN2023/108978, filed on Jul. 24, 2023.

(30) Foreign Application Priority Data
Sep. 29, 2022 (CN) 202211203935.0

(51) Int. Cl. B60L 58/13; B60L 50/60; B60W 40/076; B60W 40/105

(52) U.S. Cl. CPC B60L 58/13; B60L 50/60; B60W 40/076; B60W 40/105; B60L 2240/14; B60L 2240/54; B60L 2240/62; B60L 2240/68

(57) ABSTRACT

An energy management method for a hybrid vehicle, includes: acquiring a working condition category sequence of a current navigation route of the hybrid vehicle, and a mileage of each working condition of the current navigation route, the working condition category sequence and the mileage of each working condition are obtained according to road characteristic parameters of the current navigation route; acquiring a target state-of-charge (SOC) sequence according to the working condition category sequence and the mileage of each working condition; obtaining an equivalent factor sequence according to the working condition category sequence and the target state-of-charge sequence; obtaining instantaneous output power of a power battery of the hybrid vehicle at each moment according to the equivalent factor sequence; and controlling the hybrid vehicle according to the instantaneous output power of the power battery.

### CROSS-REFERENCE TO RELATED APPLICATIONS

This application is a continuation application of International Patent Application No. PCT/CN2023/108978, filed on Jul. 24, 2023, which is based on and claims priority to and benefits of Chinese Patent Application No. 202211203935.0, filed on Sep. 29, 2022. The entire content of all of the above-referenced applications is incorporated herein by reference.

### FIELD

The present disclosure relates to the technical field of vehicles, and particularly, to a hybrid vehicle and an energy management method and apparatus therefor, a medium and an electronic device.

### BACKGROUND

In related arts, an energy management strategy for a hybrid vehicle is based on a dynamic planning algorithm, which adopts the Equivalent Consumption Minimum Strategy (ECMS) with a constant equivalent factor. However, this strategy can only achieve optimal control under certain working conditions. When a driving condition changes, this strategy cannot guarantee the fuel economy of the vehicle.

### SUMMARY

The present disclosure solves at least one of technical problems in the related arts at least to some extent. In view of this, the present disclosure provides a hybrid vehicle and an energy management method and apparatus therefor, a non-transitory computer-readable storage medium and an electronic device, to achieve an online control of the hybrid vehicle and a global optimal control of the hybrid vehicle, thereby improving the fuel economy.

According to a first aspect, an example of the present disclosure provides an energy management method for a hybrid vehicle. The method includes: acquiring a working condition category sequence of a current navigation route of the hybrid vehicle and a mileage of each working condition of the current navigation route that are obtained according to road characteristic parameters of the current navigation route; acquiring a target state-of-charge (SOC) sequence according to the working condition category sequence and the mileage of each working condition; obtaining an equivalent factor sequence according to the working condition category sequence and the target state-of-charge sequence; obtaining instantaneous output power of a power battery of the hybrid vehicle at each moment according to the equivalent factor sequence; and controlling the hybrid vehicle according to the instantaneous output power of the power battery.

Additionally, the energy management method for a hybrid vehicle according to the example of the present disclosure may further have the following additional technical features.

According to an example of the present disclosure, the step that a target state-of-charge sequence is acquired according to the working condition category sequence and the mileage of each working condition includes: acquiring a state-of-charge of the power battery at a starting point of the current navigation route; determining a range of the state-of-charge of the hybrid vehicle at an end of each working condition according to the state-of-charge at the starting point, the working condition category sequence, and the mileage of each working condition; and obtaining the target state-of-charge sequence according to the range of the state-of-charge at the end of each working condition.

According to an example of the present disclosure, a range of the state-of-charge at an end of a first working condition of the current navigation route is obtained according to the state-of-charge at the starting point, road characteristic data of the first working condition, and a mileage of the first working condition, and a range of the state-of-charge at an end of a second working condition of the current navigation route is obtained according to the range of the state-of-charge at the end of the first working condition, road characteristic data of the second working condition, and a mileage of the second working condition, and the first working condition is a previous working condition of the second working condition.

According to an example of the present disclosure, the road characteristic data includes slope data or speed limit data.

According to an example of the present disclosure, an upper limit of the range of the state-of-charge of each working condition is a state-of-charge of the hybrid vehicle at an end of an operation of each working condition in a power generation mode, and a lower limit of the range of the state-of-charge of each working condition is a state-of-charge of the hybrid vehicle at an end of an operation of each working condition in a pure electric mode.

According to an example of the present disclosure, the target state-of-charge sequence is obtained according to a target state-of-charge selected from the range of the state-of-charge corresponding to each working condition.

According to an example of the present disclosure, the working condition category sequence and the mileage of each working condition are obtained by using a trained neural network model according to the road characteristic parameters of the current navigation route, and the trained neural network model is trained by: historical driving parameters of the hybrid vehicle on the current navigation route is acquired, historical road characteristic parameters are determined according to the historical driving parameters, and clustering processing is performed on the historical road characteristic parameters to obtain multiple working condition categories; a training dataset is constructed based on the historical road characteristic parameters and the working condition categories; and a neural network model is constructed and the neural network model is trained using the training dataset to obtain the trained neural network model.

According to an example of the present disclosure, the working condition categories include: ordinary urban roads, mildly congested urban roads, moderately congested urban roads, severely congested urban roads, expressways, highways, suburban roads, or township roads.

According to an example of the present disclosure, the road characteristic parameters include at least one of: an average speed, a maximum speed, a speed standard deviation, an average acceleration, a maximum acceleration, a minimum acceleration, an acceleration standard deviation, a acceleration time ratio, a deceleration time ratio, an uniform speed time ratio, an idle time ratio, or a cumulative mileage.

According to an example of the present disclosure, for each equivalent factor in the equivalent factor sequence, the instantaneous output power of the power battery of the hybrid vehicle under the working condition corresponding to each equivalent factor is calculated according to a formula:

$$arg H ( u , SOC ( t ) , t ) = arg {\dot{m}}_{eng} ( u , t ) + s ( t ) * S \dot{O} C ( t ) ,$$

where H (u, SOC (t), t) is a Hamiltonian function established according to an equivalent consumption minimum strategy, arg H (u,SOC(t),t) is the instantaneous output power of the power battery at a moment t, \dot{m}_{eng}(u,t) is the fuel consumption rate of an engine of the hybrid vehicle, s(t) is an equivalent factor at the moment t, SOC(t) is the state-of-charge of the power battery at the moment t, S\dot{O}C(t) is the state-of-charge change rate, and u is the fuel consumption.

According to an example of the present disclosure, the step that the hybrid vehicle is controlled according to the instantaneous output power of the power battery includes: an instantaneous required power of the hybrid vehicle at the moment t is acquired; the instantaneous output power of the power battery at the moment t is subtracted from the instantaneous required power at the moment t to obtain an instantaneous required power of an engine of the hybrid vehicle at the moment t; and the power battery and the engine are controlled according to the instantaneous output power of the power battery at the moment t and the instantaneous required power of the engine at the moment t.

According to a second aspect, an example of the present disclosure provides a non-transitory computer-readable storage medium, which stores a computer program thereon. The computer program, when executed by a processor, implements the energy management method for a hybrid vehicle described above.

According to a third aspect, an example of the present disclosure provides an electronic device, which includes a memory, a processor, and a computer program stored on the memory and executable by the processor. The computer program, when executed by the processor, to cause the processor to implement the energy management method for a hybrid vehicle described above.

According to a fourth aspect, an example of the present disclosure provides an energy management apparatus for a hybrid vehicle, which includes: an acquisition module, configured to acquire a working condition category sequence of a current navigation route of the hybrid vehicle and a mileage of each working condition of the current navigation route, the working condition category sequence and the mileage of each working condition are obtained according to road characteristic parameters of the current navigation route; acquire a target state-of-charge sequence according to the working condition category sequence and the mileage of each working condition; obtain an equivalent factor sequence according to the working condition category sequence and the target state-of-charge sequence; and obtain instantaneous output power of a power battery of the hybrid vehicle at each moment according to the equivalent factor sequence; and an energy management module, configured to control the hybrid vehicle according to the instantaneous output power of the power battery.

According to a fifth aspect, an example of the present disclosure provides a hybrid vehicle, which includes the energy management apparatus for a hybrid vehicle described above.

The hybrid vehicle and the energy management method and apparatus therefor, the medium and the electronic device according to the examples of the present disclosure can achieve the online control of the hybrid vehicle by acquiring the road characteristic parameters of the current navigation route of the hybrid vehicle, and obtaining the working condition category sequence of the current navigation route and the mileage of each working condition according to the road characteristic parameters by using the pre-trained neural network model. In addition, after the working condition category sequence and the mileage of each working condition are acquired, the target state-of-charge sequence according to the working condition category sequence and the mileage of each working condition is also acquired, to obtain the equivalent factor sequence according to the working condition category sequence and the target state-of-charge sequence, so that the equivalent factor changes according to the working condition category of the road section and the fuel economy is ensured. Since the current navigation route is acquired first, the equivalent factor sequence is obtained based on the current navigation route, the instantaneous output power of the power battery of the hybrid vehicle at each moment is obtained according to the equivalent factor sequence, and the hybrid vehicle is controlled according to the instantaneous output power of the power battery, the energy management is achieved on the current navigation route based on the equivalent factor sequence, so that the energy management is not affected by the frequency of navigation map data output, the required calculation amount is small, and the fuel economy can be better ensured in a case that the working condition changes.

The additional aspects and advantages of the present disclosure will be provided in the following description, some of which will become clear from the following description or may be learned from the practice of the present disclosure.

### BRIEF DESCRIPTION OF THE DRAWINGS

FIG. 1 is a flowchart of an energy management method for a hybrid vehicle according to an example of the present disclosure;

FIG. 2 is a schematic diagram of state-of-charge change paths according to an example of the present disclosure;

FIG. 3 is a schematic structural diagram of a neural network model according to an example of the present disclosure;

FIG. 4 is a structural block diagram of an energy management apparatus for a hybrid vehicle according to an example of the present disclosure; and

FIG. 5 is a structural block diagram of a hybrid vehicle according to an example of the present disclosure.

### DETAILED DESCRIPTION

A hybrid vehicle and an energy management method and apparatus therefor, a medium and an electronic device according to examples of the present disclosure will be described below with reference to the accompanying drawings, where the same or similar reference signs throughout represent the same or similar components or components with the same or similar functions. The examples described below with reference to the accompanying drawings are not limitations to the present disclosure.

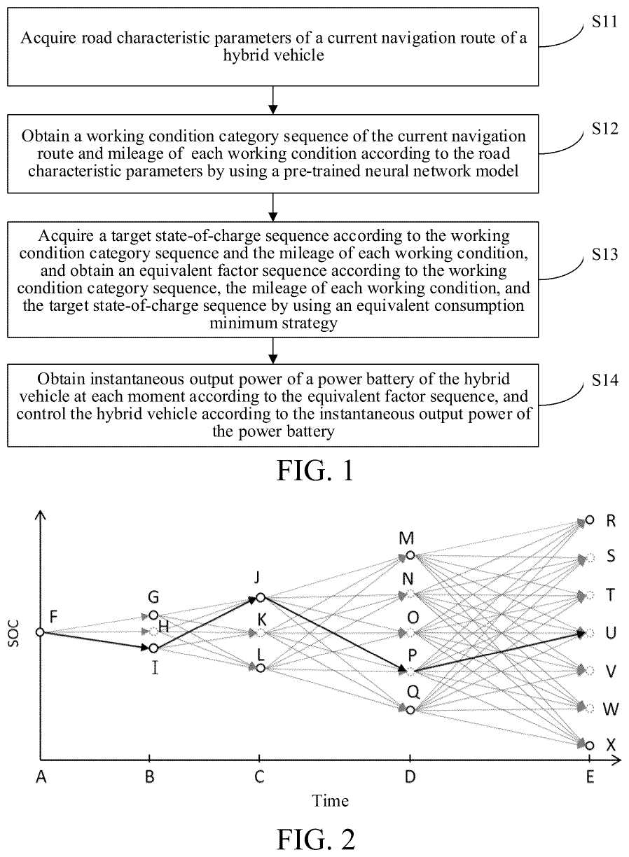

FIG. 1 is a flowchart of an energy management method for a hybrid vehicle according to an example of the present disclosure.

As shown in FIG. 1, the energy management method for a hybrid vehicle includes the following steps.

S11, road characteristic parameters of a current navigation route of the hybrid vehicle are acquired.

S12, a working condition category sequence of the current navigation route and a mileage of each working condition are obtained according to the road characteristic parameters by using a pre-trained neural network model.

S13, a target state-of-charge (SOC) sequence is acquired according to the working condition category sequence and the mileage of each working condition, and an equivalent factor sequence is obtained according to the working condition category sequence, the mileage of each working condition, and the target state-of-charge sequence by using an equivalent consumption minimum strategy.

S14, instantaneous output power of a power battery of the hybrid vehicle at each moment is obtained according to the equivalent factor sequence, and the hybrid vehicle is controlled according to the instantaneous output power of the power battery.

In an example, a vehicle simulation model is pre-established. Offline calculation is performed on related performance such as energy consumption of the hybrid vehicle under each working condition through the vehicle simulation model. The working conditions of the hybrid vehicle are divided into multiple working condition categories according to a performance calculation result. The neural network model is trained in advance, so that the neural network model can output a working condition category sequence after road characteristic parameters of a navigation map are inputted.

When the hybrid vehicle needs to be driven, road characteristic parameters of the current navigation route of the hybrid vehicle are acquired according to the navigation map, and the road characteristic parameters acquired through the navigation map are inputted into the pre-trained neural network model to obtain a working condition category and a mileage of each road section of the current navigation route. In addition, the working condition categories are sorted to obtain the working condition category sequence. A target state-of-charge sequence corresponding to the current navigation route is obtained according to the working condition category sequence and the mileage of each working condition. An equivalent factor sequence is obtained by using the equivalent consumption minimum strategy. Energy management is performed on the hybrid vehicle according to the equivalent factor sequence.

In this way, the online control of the hybrid vehicle can be achieved by acquiring the road characteristic parameters of the current navigation route of the hybrid vehicle, and obtaining the working condition category sequence of the current navigation route and the mileage of each working condition according to the road characteristic parameters by using the pre-trained neural network model. In addition, after the working condition category sequence and the mileage of each working condition are acquired, it is also required to acquire the target state-of-charge sequence according to the working condition category sequence and the mileage of each working condition, so as to obtain the equivalent factor sequence according to the working condition category sequence, the mileage of each working condition and the target state-of-charge sequence, so that the equivalent factor changes according to the working condition category of the road section and the fuel economy is ensured. Since the current navigation route is acquired first and the equivalent factor sequence is obtained based on the current navigation route, the energy management is achieved on the current navigation route based on the equivalent factor sequence, so that energy management is not affected by the frequency of navigation map data output, the required calculation amount is small, and the fuel economy can be better ensured in a case that the working condition changes.

According to some examples of the present disclosure, the step that a target state-of-charge sequence is acquired according to the working condition category sequence and the mileage of each working condition includes: a current actual state-of-charge of the power battery is acquired; a state-of-charge change range of the hybrid vehicle at the end of each working condition is determined according to the actual state-of-charge, the working condition category sequence, and the mileage of each working condition; and the target state-of-charge sequence is obtained according to the state-of-charge change range at the end of each working condition.

In an example, after the working condition category sequence and the mileage of each working condition are received, the working condition category sequence and the mileage of each working condition may be transmitted to a third-party platform to obtain the target state-of-charge sequence, or the target state-of-charge sequence may be directly calculated locally.

To calculate the target state-of-charge sequence, a first state-of-charge and a second state-of-charge at the end of a first working condition may be determined according to the current actual state-of-charge of the hybrid vehicle, the road characteristic data corresponding to the first working condition in the working condition category sequence, and the mileage of the first working condition. A state-of-charge change range at the end of the first working condition may be obtained according to the first state-of-charge and the second state-of-charge. The road characteristic data includes slope data and speed limit data. The first state-of-charge is a state-of-charge of the hybrid vehicle at the end of the first working condition in a power generation mode. The second state-of-charge is a state-of-charge of the hybrid vehicle at the end of the first working condition in a pure electric mode. For each working condition in the working condition category sequence except for the first working condition, a state-of-charge change range of the hybrid vehicle at the end of the working condition (e.g., a second working condition) is determined according to the state-of-charge change range at the end of a previous working condition (e.g., a first working condition), the road characteristic data corresponding to the working condition, and the mileage of the working condition.

In the present example, a target state-of-charge of each working condition may be selected from the state-of-charge change range corresponding to each working condition. Then, the target state-of-charge sequence is obtained according to the target state-of-charges of the working conditions.

In some examples, referring to FIG. 2, the first working condition is Working Condition 1 corresponding to Section AB. The actual state-of-charge of the hybrid vehicle at Point A is F. It is determined that the first state-of-charge at Point B is G, that is, an upper limit of the state-of-charge of Working Condition 1 is G, according to that the hybrid vehicle adopts a power generation mode, that is, the hybrid vehicle completely uses fuel under Working Condition 1 from Point A to Point B and the battery is in a charging state. It is determined that the second state-of-charge at Point B is I, that is, a lower limit of the state-of-charge of Working Condition 1 is I, according to that the hybrid vehicle adopts a pure electric mode, that is, the hybrid vehicle completely uses electricity under Working Condition 1 from Point A to Point B and the battery is in a discharging state. Accordingly, it may be determined that a state-of-charge change range under Working Condition 1 is [I, G]. It is assumed that the actual state-of-charge F under Working Condition 1 is 70%, the upper limit G of the state-of-charge at Point B is 75%, and the lower limit I of the state-of-charge is 65%, then the state-of-charge change range under Working Condition 1 is [65%, 75%].

Then, a state-of-charge change range of the hybrid vehicle under Working Condition 2 is determined according to the working condition data corresponding to Working Condition 2 and the state-of-charge change range corresponding to the previous working condition of Working Condition 2, i.e., Working Condition 1. Firstly, it is determined that a third state-of-charge at Point C is J, that is, an upper limit of the state-of-charge of Working Condition 2 is J, according to that the upper limit G of the state-of-charge of Working Condition 1 is used as the actual state-of-charge of Working Condition 2, the hybrid vehicle adopts a power generation mode, that is, the hybrid vehicle completely uses fuel under Working Condition 2 and the battery is in a charging state. Then, it is determined that a fourth state-of-charge at Point C is L, that is, a lower limit of the state-of-charge of Working Condition 2 is L, according to that the lower limit I of the state-of-charge of Working Condition 1 is used as the actual state-of-charge of Working Condition 2, the hybrid vehicle adopts a pure electric mode, that is, the hybrid vehicle completely uses electricity under Working Condition 2 from Point B to Point C and the battery is in a discharging state. Accordingly, it is determined that a state-of-charge change range under Working Condition 2 is [L, J].

Continuously referring to FIG. 2, the actual state-of-charge at Point A is F. It is assumed that Point H is selected from the state-of-charge change range [I, G] as the target state-of-charge value, then F-H is a state-of-charge change path of Working Condition 1.

The target state-of-charge value of Working Condition 1 at Section AB includes not only Point H in the state-of-charge change range mentioned above, but also the upper limit G and lower limit I of the state-of-charge. At this time, three state-of-charge change paths F-G, F-H, and F-I may be configured under Working Condition 1 at Section AB. The actual state-of-charge of Working Condition 2 at Section BC may be the target state-of-charge value at Section AB, including G, H, and I. The preset reference state-of-charge at Section BC includes J, K, and L. At this time, nine state-of-charge change paths G-J, G-K, G-L, H-J, H-K, H-L, I-J, I-K, and I-L may be configured at Section BC. Similarly, fifteen state-of-charge change paths may be configured under Working Condition 3 at Section CD, and thirty state-of-charge change paths may be configured under Working Condition 4 at Section DE. Based on the above content, it can be seen that 3*9*15*30=12150 state-of-charge change paths may be configured for the hybrid vehicle under the working conditions of the current driving road AE.

It needs to be stated that the more the target state-of-charge values of each working condition, the more the state-of-charge change paths generated, the higher the accuracy of determining the state-of-charge change path with the minimum energy consumption under the working condition, and the better the energy management effect of the hybrid vehicle achieved.

The fuel consumption and power consumption of different state-of-charge change paths are calculated and compared, the state-of-charge change path with the minimum fuel consumption and power consumption is selected as the optimal state-of-charge change path, and the optimal state-of-charge change path is used as the target state-of-charge change path of this working condition, so that the hybrid vehicle can be controlled to perform the energy management. Taking Working Condition 1 at Section AB as an example, the fuel consumption and power consumption of the state-of-charge change paths F-G, F-H, and F-I are obtained respectively, and through calculation, it is determined that the fuel consumption and power consumption of the state-of-charge change path F-I are the minimum. Therefore, the state-of-charge change path F-I is used as the target state-of-charge change path at Section AB, and I is the optimal state-of-charge at the end of Working Condition 1. Similarly, it is determined that the target state-of-charge change path at Section BC is I-J, the target state-of-charge change path at Section CD is J-P, and the target state-of-charge change path at Section DE is P-U. Therefore, the target state-of-charge change path of the driving road AE is F-I-J-P-U.

In this way, the target state-of-charge sequence can be acquired according to the working condition category sequence and the mileage of each working condition. In an example, this process may be performed on a third-party platform, thus reducing the calculation amount and calculation time of the vehicle, and the fuel economy in a case that the working condition changes can be ensured.

In some examples of the present disclosure, a process of training the neural network model includes: historical driving parameters of the hybrid vehicle on the current navigation route is acquired, historical road characteristic parameters are determined according to the historical driving parameters, and clustering processing is performed on the historical road characteristic parameters to obtain multiple working condition categories; a training dataset is constructed based on the historical road characteristic parameters and the working condition categories; and a neural network model is constructed and the neural network model is trained using the training dataset to obtain the trained neural network model. The neural network model includes an input layer, hidden layers, and an output layer. The input layer is configured to input the road characteristic parameters subjected to dimension reduction processing. The output layer is configured to output the working condition categories.

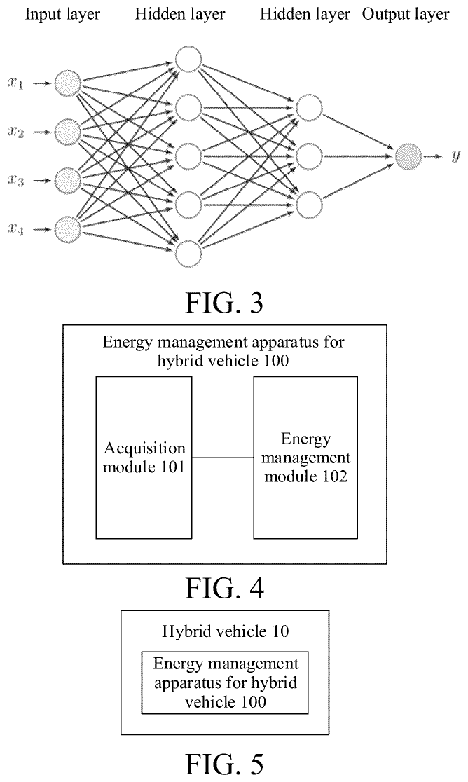

In an example, a neural network model as shown in FIG. 3 is constructed first, including an input layer, hidden layers, and an output layer. The input layer inputs x₁, x₂, . . . Xₙ as the road characteristic parameters. In the example shown in FIG. 3, n is 4. The neural network model supports road characteristic parameters with dimensions of 4. The output layer outputs y as the working condition category.

To train the neural network model, historical driving parameters of the hybrid vehicle on the current navigation route are acquired first, and historical road characteristic parameters are determined according to the historical driving parameters.

In an example, a clustering analysis algorithm is adopted to perform working condition classification, that is, a Euclidean distance method is adopted to divide the historical road characteristic parameters into different working condition categories, so as to train the neural network model according to the historical road characteristic parameters and the corresponding working condition categories.

In an embodiment, before the neural network model is trained, a principal component analysis method may also be adopted to perform dimension reduction processing on the historical road characteristic parameters, so as to train the neural network model by using the historical road characteristic parameters subjected to dimension reduction processing. In addition, the neural network model further obtains a working condition category sequence of the current navigation route and a mileage of each working condition according to the road characteristic parameters subjected to dimension reduction processing.

In some examples of the present disclosure, the working condition categories include: ordinary urban roads, mildly congested urban roads, moderately congested urban roads, severely congested urban roads, expressways, highways, suburban roads, and township roads.

In some examples of the present disclosure, the road characteristic parameters include at least one of: an average speed, a maximum speed, a speed standard deviation, an average acceleration, a maximum acceleration, a minimum acceleration, an acceleration standard deviation, a acceleration time ratio, a deceleration time ratio, an uniform speed time ratio, an idle time ratio, or a cumulative mileage.

In some examples of the present disclosure, the step that instantaneous output power of a power battery of the hybrid vehicle at each moment is obtained according to the equivalent factor sequence includes: for each equivalent factor in the equivalent factor sequence, the instantaneous output power of the battery of the hybrid vehicle corresponding to the equivalent factor is calculated according to the following formula:

$$arg H ( u , SOC ( t ) , t ) = arg {\dot{m}}_{eng} ( u , t ) + s ( t ) * S \dot{O} C ( t ) ,$$

where H (u, SOC (t), t) is a Hamiltonian function established according to an equivalent consumption minimum strategy, arg H (u,SOC(t),t) is the instantaneous output power of the power battery of the hybrid vehicle at moment t, \dot{m}_{eng}(u,t) is the fuel consumption rate of an engine of the hybrid vehicle, s(t) is an equivalent factor at moment t, SOC(t) is the state-of-charge of the power battery at moment t, S\dot{O}C(t) is the state-of-charge change rate, and u is the fuel consumption.

In an example, a Hamiltonian function is established, each working condition category is computed and a relationship among the working condition categories, the target state-of-charge, and the equivalent factors is constructed by using the equivalent consumption minimum strategy. Solving the Hamiltonian function can establish the relationship between the target state-of-charge of the battery and the equivalent factor under the current working condition category, thus the optimal equivalent factor in each target state-of-charge under the current working condition category is determined. After the optimal equivalent factor is obtained, the instantaneous output power of the battery of the hybrid vehicle corresponding to the optimal equivalent factor can be obtained, and the hybrid vehicle can be controlled according to the instantaneous output power of the power battery. For example, after the instantaneous output power of the power battery at moment t is acquired, the instantaneous required power of the hybrid vehicle at the moment t can be acquired. The instantaneous output power of the power battery at the moment t is subtracted from the instantaneous required power at the moment t to obtain instantaneous required power of an engine of the hybrid vehicle at the moment t. The power battery and the engine are controlled according to the instantaneous output power of the power battery at the moment t and the instantaneous required power of the engine at the moment t.

In this way, the output power can be obtained based on the equivalent factor optimized in real time, thus achieving the full time-domain optimal energy management of the entire navigation route.

To sum up, the energy management method for a hybrid vehicle according to the examples of the present disclosure can achieve the online control of the hybrid vehicle by acquiring the road characteristic parameters of the current navigation route of the hybrid vehicle, and obtaining the working condition category sequence of the current navigation route and the mileage of each working condition according to the road characteristic parameters by using the pre-trained neural network model. In addition, after the working condition category sequence and the mileage of each working condition are acquired, it is also required to acquire the target state-of-charge sequence according to the working condition category sequence and the mileage of each working condition, so as to obtain the equivalent factor sequence according to the working condition category sequence, the mileage of each working condition, and the target state-of-charge sequence, so that the equivalent factor changes according to the working condition category of the road section and the fuel economy is ensured. Since the current navigation route is acquired first and the equivalent factor sequence is obtained based on the current navigation route, the energy management is achieved on the current navigation route based on the equivalent factor sequence, so that the energy management is not affected by the frequency of navigation map data output, the required calculation amount is small, and the fuel economy can be better ensured optimized in a case that the working condition changes.

Based on the energy management method for a hybrid vehicle according to the above examples, the present disclosure provides a non-transitory computer-readable storage medium.

In an example of the present disclosure, the non-transitory computer-readable storage medium stores a computer program. The computer program, when executed by a processor, implements the energy management method for a hybrid vehicle described above.

Through implementing the energy management method for a hybrid vehicle described above, the non-transitory computer-readable storage medium according to the example of the present disclosure can achieve the online control of the hybrid vehicle by acquiring the road characteristic parameters of the current navigation route of the hybrid vehicle, and obtaining the working condition category sequence of the current navigation route and the mileage of each working condition according to the road characteristic parameters by using the pre-trained neural network model. In addition, after the working condition category sequence and the mileage of each working condition are acquired, it is also required to acquire the target state-of-charge sequence according to the working condition category sequence and the mileage of each working condition, so as to obtain the equivalent factor sequence according to the working condition category sequence, the mileage of each working condition and the target state-of-charge sequence, so that the equivalent factor changes according to the working condition category of the road section and the fuel economy is ensured/optimized. Since the current navigation route is acquired first and the equivalent factor sequence is obtained based on the current navigation route, the energy management is achieved on the current navigation route based on the equivalent factor sequence, so that the energy management is not affected by the frequency of navigation map data output, the required calculation amount is small, and the fuel economy can be better ensured in a case that the working condition changes.

Based on the energy management method for a hybrid vehicle according to the above examples, the present disclosure provides an electronic device.

In an example of the present disclosure, the electronic device includes a memory, a processor, and a computer program stored on the memory and executable on the processor. The computer program, when executed by the processor, to cause the processor of the electronic device to implement the energy management method for a hybrid vehicle described above.

Through implementing the energy management method for a hybrid vehicle described above, the electronic device according to the example of the present disclosure can achieve the online control of the hybrid vehicle by acquiring the road characteristic parameters of the current navigation route of the hybrid vehicle, and obtaining the working condition category sequence of the current navigation route and the mileage of each working condition according to the road characteristic parameters by using the pre-trained neural network model. In addition, after the working condition category sequence and the mileage of each working condition are acquired, it is also required to acquire the target state-of-charge sequence according to the working condition category sequence and the mileage of each working condition, so as to obtain the equivalent factor sequence according to the working condition category sequence, the mileage of each working condition, and the target state-of-charge sequence, so that the equivalent factor changes according to the working condition category of the road section and the fuel economy is ensured. Since the current navigation route is acquired first and the equivalent factor sequence is obtained based on the current navigation route, the energy management is achieved on the current navigation route based on the equivalent factor sequence, so that the energy management is not affected by the frequency of navigation map data output, the required calculation amount is small, and the fuel economy can be better ensured in a case that the working condition changes.

FIG. 4 is a structural block diagram of an energy management apparatus for a hybrid vehicle according to an example of the present disclosure.

As shown in FIG. 4, the energy management apparatus 100 for a hybrid vehicle includes an acquisition module 101 and an energy management module 102.

In an example, the acquisition module 101 is configured to acquire road characteristic parameters of a current navigation route of the hybrid vehicle, obtain a working condition category sequence of the current navigation route and a mileage of each working condition according to the road characteristic parameters by using a pre-trained neural network model, acquire a target state-of-charge sequence according to the working condition category sequence and the mileage of each working condition, obtain an equivalent factor sequence according to the working condition category sequence, the mileage of each working condition, and the target state-of-charge sequence by using an equivalent consumption minimum strategy, and obtain instantaneous output power of a power battery of the hybrid vehicle at each moment according to the equivalent factor sequence. The energy management module 102 is configured to control the hybrid vehicle according to the instantaneous output power of the power battery.

It needs to be stated that for other implementations of the energy management apparatus for a hybrid vehicle according to the example of the present disclosure, reference may be made to the energy management method for a hybrid vehicle described above.

The energy management apparatus for a hybrid vehicle according to the example of the present disclosure can achieve the online control of the hybrid vehicle by acquiring the road characteristic parameters of the current navigation route of the hybrid vehicle, and obtaining the working condition category sequence of the current navigation route and the mileage of each working condition according to the road characteristic parameters by using the pre-trained neural network model. In addition, after the working condition category sequence and the mileage of each working condition are acquired, it is also required to acquire the target state-of-charge sequence according to the working condition category sequence and the mileage of each working condition, so as to obtain the equivalent factor sequence according to the working condition category sequence, the mileage of each working condition and the target state-of-charge sequence, so that the equivalent factor changes according to the working condition category of the road section and the fuel economy is ensured. Since the current navigation route is acquired first and the equivalent factor sequence is obtained based on the current navigation route, the energy management is achieved on the current navigation route based on the equivalent factor sequence, so that the energy management is not affected by the frequency of navigation map data output, the required calculation amount is small, and the fuel economy can be better ensured in a case that the working condition changes.

Based on the energy management method and apparatus for a hybrid vehicle according to the above examples, the present disclosure provides a hybrid vehicle.

FIG. 5 is a structural block diagram of a hybrid vehicle according to an example of the present disclosure.

As shown in FIG. 5, the hybrid vehicle 10 includes the energy management apparatus 100 for a hybrid vehicle described above.

Through the energy management apparatus for a hybrid vehicle described above, the hybrid vehicle according to the example of the present disclosure can achieve the online control of the hybrid vehicle by acquiring the road characteristic parameters of the current navigation route of the hybrid vehicle, and obtaining the working condition category sequence of the current navigation route and the mileage of each working condition according to the road characteristic parameters by using the pre-trained neural network model. In addition, after the working condition category sequence and the mileage of each working condition are acquired, it is also required to acquire the target state-of-charge sequence according to the working condition category sequence and the mileage of each working condition, so as to obtain the equivalent factor sequence according to the working condition category sequence, the mileage of each working condition and the target state-of-charge sequence, so that the equivalent factor changes according to the working condition category of the road section and the fuel economy is ensured. Since the current navigation route is acquired first and the equivalent factor sequence is obtained based on the current navigation route, the energy management is achieved on the current navigation route based on the equivalent factor sequence, so that the energy management is not affected by the frequency of navigation map data output, the required calculation amount is small, and the fuel economy can be better ensured in a case that the working condition changes.

It needs to be stated that the logic and/or steps shown in the flowcharts or described in any other manner herein, may be considered as a sequenced list of executable instructions for implementing logical functions, may be implemented in any computer-readable medium to be used by an instruction execution system, apparatus or device (for example, a computer-based system, a system including a processor, or another system that can obtain an instruction from the instruction execution system, apparatus or device and execute the instruction) or to be used by combining such instruction execution systems, apparatuses or devices. In this specification of the present disclosure, the “computer-readable medium” may be any apparatus that may include, store, communicate, propagate, or transmit programs to be used by the instruction execution system, apparatus or device or to be used in combination with the instruction execution system, apparatus or device. More examples (a non-exhaustive list) of the computer-readable medium may include: an electrical connection (electronic device) having one or more wires, a portable computer diskette (magnetic apparatus), a random access memory (RAM), a read-only memory (ROM), an erasable programmable read-only memory (EPROM or flash memory), an optical fiber apparatus, and a portable compact disk read-only memory (CDROM). In addition, the computer-readable medium can even be paper or other suitable media on which the program can be printed, because the program can be obtained electronically by, for example, optically scanning paper or other media, then editing, interpreting, or processing in other suitable ways if necessary, and then the program is stored in a computer memory.

It should be understood that each part of the present disclosure may be implemented by using hardware, software, firmware, or a combination thereof. In the foregoing implementations, multiple steps or methods may be implemented by using software or firmware that are stored in a memory and are executed by a proper instruction execution system. If hardware is used for implementation, same as in another implementation, implementation may be performed by any one of the following technologies well known in the art or a combination thereof: a discrete logic circuit including a logic gate circuit for implementing a logic function of a data signal, a dedicated integrated circuit including a proper combined logic gate circuit, a programmable gate array (PGA), a field programmable gate array (FPGA), and the like.

In the description of this specification, the description with reference to terms “an example”, “some examples”, “an example”, “a specific example”, “some examples” and the like means that features, structures, materials or characteristics described in combination with the example(s) or example(s) are included in at least one example or example of the present disclosure. In this specification, descriptions of the foregoing terms do not necessarily refer to the same example or example. In addition, the described features, structures, materials, or characteristics may be combined in a proper manner in any one or more of the examples or examples.

In the description of this specification, orientation or position relationships indicated by the terms such as “center”, “longitudinal”, “transverse”, “length”, “width”, “thickness”, “up”, “down”, “front”, “back”, “left”, “right”, “vertical”, “horizontal”, “top”, “bottom”, “inside”, “outside”, “clockwise”, “anticlockwise”, “axial”, “radial”, and “circumferential” are based on orientation or position relationships shown in the accompanying drawings, are not to indicate or imply that the mentioned apparatus or component needs to have a particular orientation or needs to be constructed and operated in a particular orientation, and should not be construed as limitations on the present disclosure.

In addition, terms “first” and “second” are used merely for the purpose of description, and should not be construed as indicating or implying relative importance or implying a quantity of indicated technical features. Therefore, a feature defined by “first” or “second” may explicitly indicate or implicitly include at least one of such features. In the descriptions of the present disclosure, unless explicitly specified, “multiple” means at least two, for example, two or three.

In the description of this specification, unless otherwise stated, terms such as “mounting”, “connected”, “connection” and “fixing” should be understood in a broad sense. For example, it may be fixed connection, detachable connection, or integral connection; or it may be mechanical connection or electrical connection; or it may be direct connection, indirect connection through an intermediary, or internal communication between two components or interaction relationship between two components, unless otherwise explicitly defined. A person of ordinary skill in the art can understand meanings of the terms in the present disclosure based on certain situations.

In the present disclosure, unless otherwise explicitly specified or defined, a first feature is located “above” or “below” a second feature may be that the first feature is in a direct contact with the second feature, or the first feature is in an indirect contact with the second feature through an intermediary. In addition, the first feature is “above”, “over”, or “on” the second feature may be that the first feature is directly above or obliquely above the second feature, or may merely indicate that the horizontal position of the first feature is higher than that of the second feature. The first feature is “below”, “under”, and “beneath” the second feature may be that the first feature is right below the second feature or at an inclined bottom of the second feature, or may merely indicate that the horizontal position of the first feature is lower than that of the second feature.

Although the examples of the present disclosure have been shown and described above, it can be understood that, the foregoing examples should not be limitation to the present disclosure. A person of ordinary skill in the art can make changes, modifications, replacements, or variations to the foregoing examples within the scope of the present disclosure.

What is claimed is:

1. An energy management method for a hybrid vehicle, comprising:
acquiring a working condition category sequence of a current navigation route of the hybrid vehicle and a mileage of each working condition of the current navigation route that are obtained according to road characteristic parameters of the current navigation route;
acquiring a target state-of-charge (SOC) sequence according to the working condition category sequence and the mileage of each working condition;
obtaining an equivalent factor sequence according to the working condition category sequence and the target state-of-charge sequence;
obtaining instantaneous output power of a power battery of the hybrid vehicle at each moment according to the equivalent factor sequence; and
controlling the hybrid vehicle according to the instantaneous output power of the power battery.

2. The energy management method according to claim 1, wherein the acquiring the target state-of-charge sequence according to the working condition category sequence and the mileage of each working condition comprises:
acquiring a state-of-charge of the power battery at a starting point of the current navigation route;
determining a range of the state-of-charge of the hybrid vehicle at an end of each working condition according to the state-of-charge at the starting point, the working condition category sequence, and the mileage of each working condition; and
obtaining the target state-of-charge sequence according to the range of the state-of-charge at the end of each working condition.

3. The energy management method according to claim 2, wherein:
a range of the state-of-charge at an end of a first working condition of the current navigation route is obtained according to the state-of-charge at the starting point, road characteristic data of the first working condition, and a mileage of the first working condition; and
a range of the state-of-charge at an end of a second working condition of the current navigation route is obtained according to the range of the state-of-charge at the end of the first working condition, road characteristic data of the second working condition, and a mileage of the second working condition, and the first working condition is a previous working condition of the second working condition.

4. The energy management method according to claim 3, wherein the road characteristic data comprises slope data or speed limit data.

5. The energy management method according to claim 2, wherein an upper limit of the range of the state-of-charge of each working condition is a state-of-charge of the hybrid vehicle at an end of an operation of each working condition in a power generation mode, and a lower limit of the range of the state-of-charge of each working condition is a state-of-charge of the hybrid vehicle at an end of an operation of each working condition in a pure electric mode.

6. The energy management method according to claim 2, wherein the target state-of-charge sequence is obtained according to a target state-of-charge selected from the range of the state-of-charge corresponding to each working condition.

7. The energy management method according to claim 1, wherein the working condition category sequence and the mileage of each working condition are obtained by using a trained neural network model according to the road characteristic parameters of the current navigation route, and the trained neural network model is trained by:
acquiring historical driving parameters of the hybrid vehicle on the current navigation route, determining historical road characteristic parameters according to the historical driving parameters, and performing clustering processing on the historical road characteristic parameters to obtain a plurality of working condition categories;
constructing a training dataset based on the historical road characteristic parameters and the working condition categories; and
constructing a neural network model and training the neural network model using the training dataset to obtain the trained neural network model.

8. The energy management method according to claim 7, wherein the working condition categories comprise: ordinary urban roads, mildly congested urban roads, moderately congested urban roads, severely congested urban roads, expressways, highways, suburban roads, or township roads.

9. The energy management method according to claim 1, wherein the road characteristic parameters comprise at least one of: an average speed, a maximum speed, a speed standard deviation, an average acceleration, a maximum acceleration, a minimum acceleration, an acceleration standard deviation, a acceleration time ratio, a deceleration time ratio, an uniform speed time ratio, an idle time ratio, or a cumulative mileage.

10. The energy management method according to claim 1, wherein
for each equivalent factor in the equivalent factor sequence, calculating an instantaneous output power of the power battery of the hybrid vehicle under a working condition corresponding to each equivalent factor according to a formula:
$$arg H ( u , SOC ( t ) , t ) = arg {\dot{m}}_{eng} ( u , t ) + s ( t ) * S \dot{O} C ( t ) ,$$
wherein H (u, SOC (t), t) is a Hamiltonian function established according to an equivalent consumption minimum strategy, arg H (u,SOC(t),t) is an instantaneous output power of the power battery at a moment t, \dot{m}_{eng}(u,t) is a fuel consumption rate of an engine of the hybrid vehicle, s(t) is an equivalent factor at the moment t, SOC(t) is a state-of-charge of the power battery at the moment t, S\dot{O}C(t) is a state-of-charge change rate, and u is a fuel consumption.

11. The energy management method according to claim 10, wherein the controlling the hybrid vehicle according to the instantaneous output power of the power battery comprises:
acquiring an instantaneous required power of the hybrid vehicle at the moment t;
subtracting the instantaneous output power of the power battery at the moment t from the instantaneous required power at the moment t to obtain an instantaneous required power of the engine of the hybrid vehicle at the moment t; and
controlling the power battery and the engine according to the instantaneous output power of the power battery at the moment t and the instantaneous required power of the engine at the moment t.

12. A non-transitory computer-readable storage medium, storing a computer program thereon, the computer program, when executed by a processor, to cause the processor to perform operations comprising:
acquiring a working condition category sequence of a current navigation route of a hybrid vehicle and a mileage of each working condition of the current navigation route that are obtained according to road characteristic parameters of the current navigation route;
acquiring a target state-of-charge (SOC) sequence according to the working condition category sequence and the mileage of each working condition;
obtaining an equivalent factor sequence according to the working condition category sequence and the target state-of-charge sequence;
obtaining instantaneous output power of a power battery of the hybrid vehicle at each moment according to the equivalent factor sequence; and
controlling the hybrid vehicle according to the instantaneous output power of the power battery.

13. An electronic device, comprising a memory, a processor, and a computer program stored on the memory and executable by the processor, the processor, is configured to execute the computer program to perform operations comprising:
acquiring a working condition category sequence of a current navigation route of a hybrid vehicle and a mileage of each working condition of the current navigation route that are obtained according to road characteristic parameters of the current navigation route;
acquiring a target state-of-charge (SOC) sequence according to the working condition category sequence and the mileage of each working condition;
obtaining an equivalent factor sequence according to the working condition category sequence and the target state-of-charge sequence;
obtaining instantaneous output power of a power battery of the hybrid vehicle at each moment according to the equivalent factor sequence; and
controlling the hybrid vehicle according to the instantaneous output power of the power battery.

14. The electronic device according to claim 13, wherein the acquiring the target state-of-charge sequence according to the working condition category sequence and the mileage of each working condition comprises:
acquiring a state-of-charge of the power battery at a starting point of the current navigation route;
determining a range of the state-of-charge of the hybrid vehicle at an end of each working condition according to the state-of-charge at the starting point, the working condition category sequence, and the mileage of each working condition; and
obtaining the target state-of-charge sequence according to the range of the state-of-charge at the end of each working condition.

15. The electronic device according to claim 14, wherein:
a range of the state-of-charge at an end of a first working condition of the current navigation route is obtained according to the state-of-charge at the starting point, road characteristic data of the first working condition, and a mileage of the first working condition; and
a range of the state-of-charge at an end of a second working condition of the current navigation route is obtained according to the range of the state-of-charge at the end of the first working condition, road characteristic data of the second working condition, and a mileage of the second working condition, and the first working condition is a previous working condition of the second working condition.

16. The electronic device according to claim 15, wherein the road characteristic data comprises slope data or speed limit data.

17. The electronic device according to claim 14, wherein an upper limit of the range of the state-of-charge of each working condition is a state-of-charge of the hybrid vehicle at an end of an operation of each working condition in a power generation mode, and a lower limit of the range of the state-of-charge of each working condition is a state-of-charge of the hybrid vehicle at an end of an operation of each working condition in a pure electric mode.

18. The electronic device according to claim 14, wherein the target state-of-charge sequence is obtained according to a target state-of-charge selected from the range of the state-of-charge corresponding to each working condition.

19. The electronic device according to claim 13, wherein the working condition category sequence and the mileage of each working condition are obtained by using a trained neural network model according to the road characteristic parameters of the current navigation route, and the trained neural network model is trained by:
acquiring historical driving parameters of the hybrid vehicle on the current navigation route, determining historical road characteristic parameters according to the historical driving parameters, and performing clustering processing on the historical road characteristic parameters to obtain a plurality of working condition categories;
constructing a training dataset based on the historical road characteristic parameters and the working condition categories; and
constructing a neural network model and training the neural network model using the training dataset to obtain the trained neural network model.

20. A hybrid vehicle, comprising the electronic device according to claim 13.
